(19) United States
(12) Patent Application Publication
(10) Pub. No.: US 2019/0036481 A1
(43) Pub. Date: Jan. 31, 2019

(54) PHOTOVOLTAIC MODULE WITH DISTRIBUTED POWER CONVERSION CIRCUITS

(71) Applicant: SunPower Corporation, San Jose, CA (US)

(72) Inventor: Patrick CHAPMAN, Austin, TX (US)

(73) Assignee: SunPower Corporation, San Jose, CA (US)

(21) Appl. No.: 15/982,842

(22) Filed: May 17, 2018

Related U.S. Application Data
(60) Provisional application No. 62/536,838, filed on Jul. 25, 2017.

(51) Int. Cl. H02S 40/32; H02M 7/537

(52) U.S. Cl. CPC H02S 40/32; H02M 7/537

(57) ABSTRACT

A photovoltaic module includes solar cells and a power conversion circuit. The power conversion circuit includes an in-laminate circuit that is disposed with the solar cells within a laminate of the photovoltaic module. The power conversion circuit further includes an external circuit disposed outside of the laminate. The external circuit is in an enclosure, such as a junction box. The external circuit includes magnetic components, such as an inductor or a transformer.

### CROSS-REFERENCE TO RELATED APPLICATION

This application claims the benefit of U.S. Provisional Patent Application Ser. No. 62/536,838, filed Jul. 25, 2017, which is incorporated herein by reference in its entirety.

### TECHNICAL FIELD

Embodiments of the subject matter described herein relate generally to photovoltaic modules.

### BACKGROUND

Solar cells are well known devices for converting solar radiation to electrical energy. A solar cell has a front side that faces the sun during normal operation to collect solar radiation and a backside opposite the front side. Solar radiation impinging on the solar cell creates electrical charges that may be harnessed to power an electrical circuit, such as a load.

Solar cells may be packaged in a photovoltaic module. So-called module-level power electronics (MLPE) are power conversion circuits that are deployed with a photovoltaic module. Examples of MPLE's include power optimizers and microinverters. Power optimizers include DC-DC converter circuits that control the output power of a string of solar cells.

A photovoltaic inverter converts DC (direct current) output generated from the solar cells to AC (alternating current) output. A string inverter is a photovoltaic inverter that performs DC-to-AC conversion for all photovoltaic modules of the photovoltaic system, whereas a microinverter is a photovoltaic inverter that performs the DC-to-AC conversion per photovoltaic module.

Embodiments of the present invention include power conversion circuits that may be readily incorporated as part of a photovoltaic module.

### BRIEF SUMMARY

In one embodiment, a photovoltaic module comprises a plurality of solar cells and a power conversion circuit. The power conversion circuit is distributed in that it has electronics components that are within the laminate and electronics components that are in an external enclosure, such as a junction box. The power conversion circuit may comprise a first subcircuit and a second subcircuit. The first subcircuit is in-laminate in that it is within the laminate along with the solar cells. The second subcircuit is disposed outside of the laminate in the external enclosure. The second subcircuit may comprise magnetic components, such inductors or transformers. The power conversion circuit may be a DC-DC converter or a microinverter, for example.

These and other features of the present disclosure will be readily apparent to persons of ordinary skill in the art upon reading the entirety of this disclosure, which includes the accompanying drawings and claims.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures. The drawings are not necessarily drawn to scale.

FIG. 1 is a perspective view of a photovoltaic module in accordance with an embodiment of the present invention.

FIGS. 2A and 2B are plan views that show the bottom side of a photovoltaic module in accordance with embodiments of the present invention.

FIG. 3 is a cross-sectional view of a photovoltaic module in accordance with an embodiment of the present invention.

FIG. 4 is a plan view that schematically illustrates placement of an in-laminate circuit relative to solar cells in the laminate in accordance with embodiments of the present invention.

FIG. 5 is a schematic diagram of a power conversion circuit in accordance with an embodiment of the present invention.

FIG. 6 is a schematic diagram of a power conversion circuit in accordance with another embodiment of the present invention.

FIG. 7 is a schematic diagram of a power conversion circuit in accordance with yet another embodiment of the present invention.

FIG. 8 is a schematic diagram of a power conversion circuit in accordance with yet another embodiment of the present invention.

FIG. 9 is a structural representation of inductors of the power conversion circuit of FIG. 8 in accordance with an embodiment of the present invention.

FIG. 10 is a schematic diagram of a magnetic circuit in accordance with an embodiment of the present invention.

FIG. 11 is a structural representation of inductors of the magnetic circuit of FIG. 10 in accordance with an embodiment of the present invention.

FIG. 12 is a schematic diagram of a magnetic circuit in accordance with another embodiment of the present invention.

FIG. 13 is a schematic diagram of a power conversion circuit in accordance with yet an embodiment of the present invention.

FIG. 14 is a structural representation of a transformer of the power conversion circuit of FIG. 13 in accordance with an embodiment of the present invention.

FIG. 15 is a schematic diagram of a substring of a photovoltaic module in accordance with an embodiment of the present invention.

FIG. 16 is a schematic diagram of a photovoltaic module in accordance with another embodiment of the present invention.

FIG. 17 is a schematic diagram of a microinverter of the photovoltaic module of FIG. 16 in accordance with an embodiment of the present invention.

### DETAILED DESCRIPTION

In the present disclosure, numerous specific details are provided, such as examples of structures, components, and methods, to provide a thorough understanding of embodiments of the invention. Persons of ordinary skill in the art will recognize, however, that the invention can be practiced without one or more of the specific details. In other instances, well-known details are not shown or described to avoid obscuring aspects of the invention.

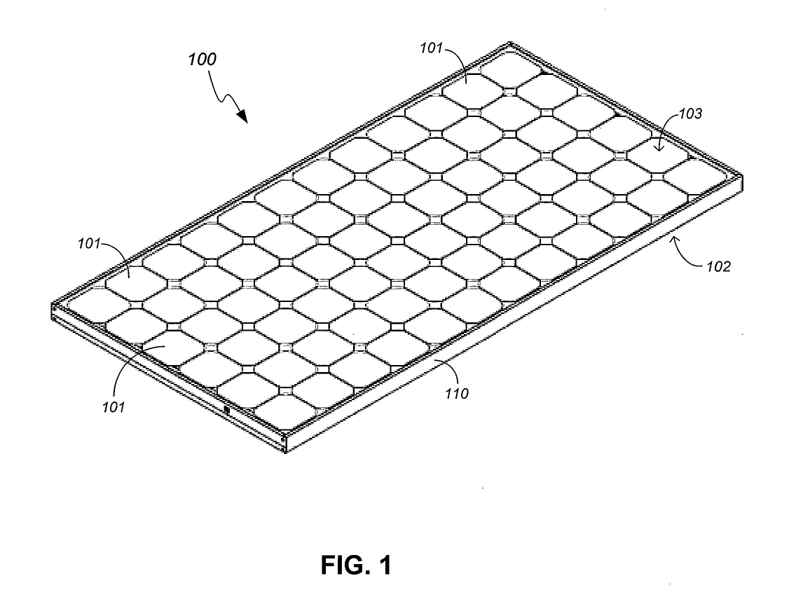

FIG. 1 is a perspective view of a photovoltaic module 100 in accordance with an embodiment of the present invention. In the example of FIG. 1, the photovoltaic module 100 includes an array of solar cells 101, only some of which are labeled for clarity of illustration. A solar cell 101 may comprise an all backside contact solar cell, a monolithic multi-diode (MMD) solar cell, or some other solar cell. The solar cells 101 may be electrically interconnected in series. A string of solar cells 101 may also be divided into substrings, with each substring being controlled by a power conversion circuit, such as a DC-DC converter.

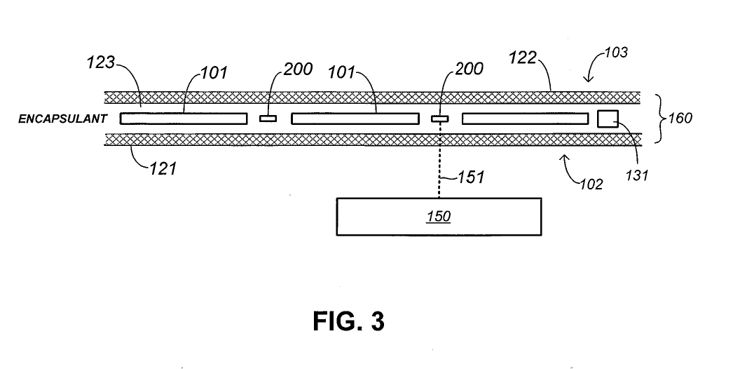

The solar cells 101 may be packaged together in a photovoltaic laminate (see FIG. 3, laminate 160), with the laminate being mechanically supported by a frame 110. FIG. 1 shows the topside (see arrow 103) of the photovoltaic module 100. The topside of the photovoltaic module 100 faces the sun during normal operation to allow the front sides of the solar cells 101 to receive incident light. The bottom side (see arrow 102) of the photovoltaic module 100 is opposite the topside.

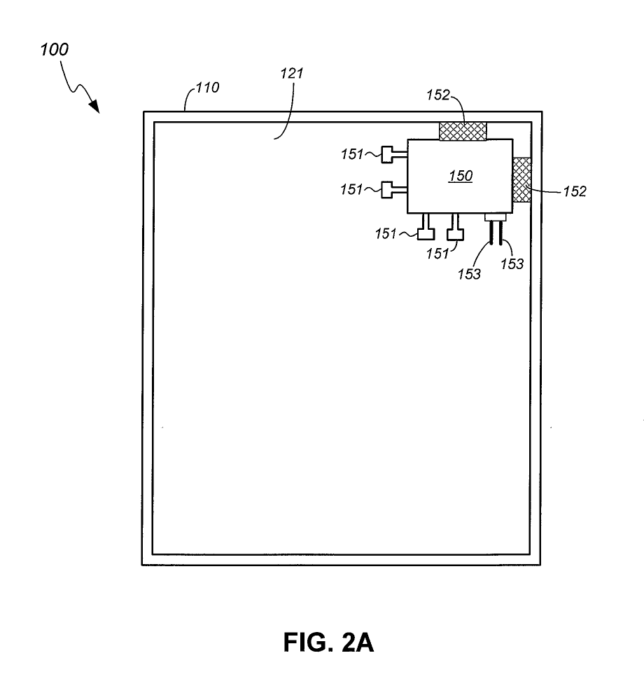

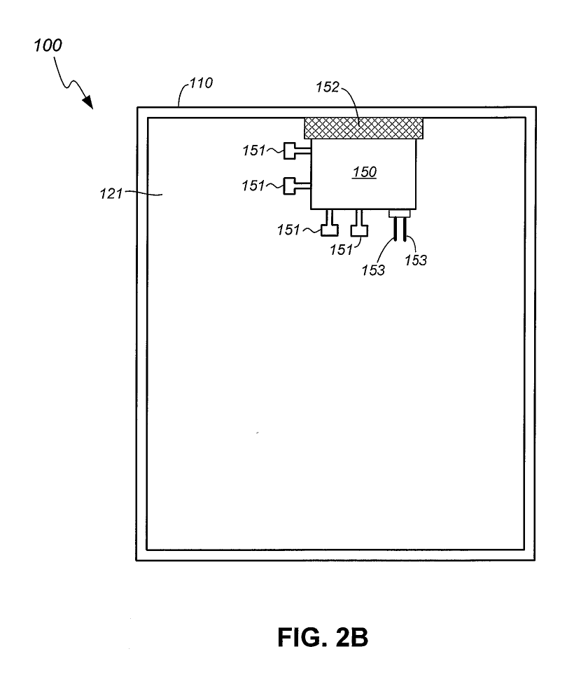

FIGS. 2A and 2B are plan views, showing the bottom side of the photovoltaic module 100 in accordance with embodiments of the present invention. FIGS. 2A 2B are the same except that an enclosure 150 is on a corner of the frame 110 in FIG. 2A, and is centered on a top edge of the frame 110 in FIG. 2B. The enclosure 150 may be placed in other locations outside of the photovoltaic laminate without detracting from the merits of the present invention.

FIGS. 2A and 2B show a backsheet 121 (shown also in FIG. 3), which in one embodiment is the outermost protective layer of the laminate. An enclosure 150 provides an enclosure for externally housing bulky electronics components (e.g., magnetic components, such as inductors and transformers) of the photovoltaic module 100. In one embodiment, the enclosure 150 comprises a junction box.

The enclosure 150 may be mounted to the frame 110 by way of one or more mounting hardware 152, such as beam, bracket, or other suitable mechanical configuration. Electronics components, such as inductors, transformers, capacitors, etc., housed in the enclosure 150 may be electrically connected to in-laminate electronics components by way of one or more electrical connections 151. An electrical connection 151 may comprise a ribbon cable, wiring, etc., that extends into the laminate to electrically connect to an electronics component that is in the laminate. The electrical connection 151 may be electrically connected to in-laminate electronics component using any suitable connection configuration that is commonly employed in the photovoltaic industry.

Electronics components housed in the enclosure 150 may be electrically connected to electrical circuits outside the enclosure 150 by way of electrical wirings 153. For example, the electrical wirings 153 may be electrically connected to the power grid, another photovoltaic module, or a circuit external to the photovoltaic module 100. For ease of interconnection, the electrical wirings 153 may be incorporated into various types of connectors commonly employed in the photovoltaic industry, such as MC4 connectors.

FIG. 3 is a cross-sectional view of the photovoltaic module 100 in accordance with an embodiment of the present invention. In the example of FIG. 3, a photovoltaic laminate 160 comprises a front cover 122 (e.g., glass), an encapsulant 123, and a backsheet 121. The photovoltaic laminate 160 provides an environmental seal that protects components within the laminate.

The topside (see arrow 103) and bottom side (see arrow 102) of the photovoltaic module 100 are noted in FIG. 3 for orientation purposes. In the example of FIG. 3, in-laminate components, i.e., components surrounded/within the laminate 160, such as the solar cells 101 and in-laminate circuits 200, are encapsulated by the encapsulant 123. The front cover 122, the encapsulant 123, and the backsheet 121 may be formed as the laminate 160 (to protectively encapsulate the solar cells 101 and the in-laminate circuits 200) by vacuum lamination or other suitable lamination process.

In one embodiment, a power conversion circuit includes an in-laminate circuit 200 that is in-laminate and an external circuit (i.e., not in the laminate 160) that is housed in the enclosure 150. The in-laminate circuit 200 may comprise an integrated circuit (IC) chip, such as a semiconductor die that is free-mounted (i.e., not mounted on a printed circuit board). In-laminate components of the power conversion circuit may be formed in an IC chip using suitable semiconductor processing technology. The in-laminate circuit 200 may also comprise a circuit that is mounted on a low-profile circuit board or similar planar, relatively flat support substrate suitable for mounting planar electronics components.

In some embodiments, other in-laminate components (see FIG. 3, 131) of the photovoltaic module 100 may include light sensors (e.g., photocells), tracking devices, accelerometers, and/or temperature sensors. Light and temperature sensors may be used for power point tracking control, estimating weather conditions, or for diagnostic purposes. A tracking device, such as wireless identification (ID) tag, may be used to determine relative location of photovoltaic modules or to provide a serial number, status or other photovoltaic module information. A combination of ultrasonic actuators and sensors may be used to provide proximity and orientation information so that an array of photovoltaic modules may be mapped physically without significant manual effort. An accelerometer may be used to detect abrupt events, such the module being dropped or stepped on, which may be useful in warranty claims or other forensic analysis.

To prevent degradation of the laminate 160, bulky electronics components, such as magnetic components (e.g., inductors and transformers) and physically large capacitors, of the power conversion circuit may be externally housed in the enclosure 150. One or more electrical connections 151 may electrically connect an in-laminate circuit 200 to an external circuit in the enclosure 150.

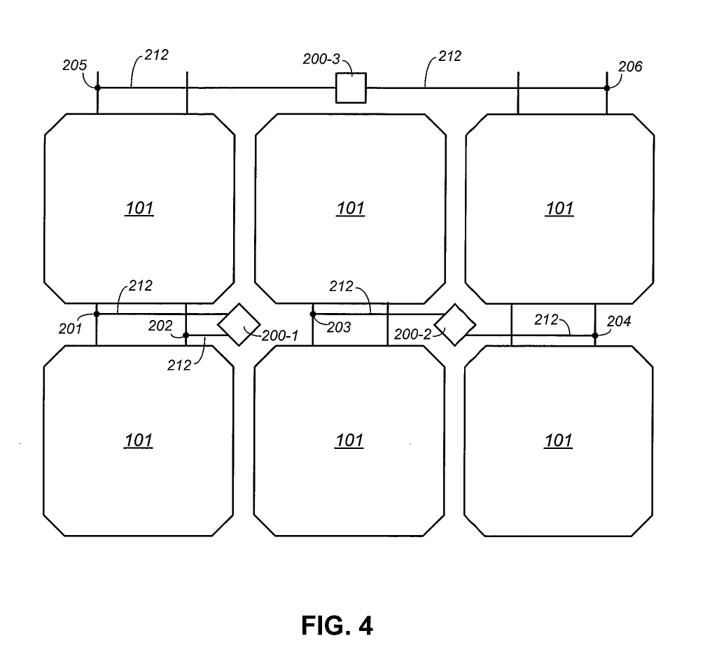

FIG. 4 is a plan view that schematically illustrates placement of an in-laminate circuit 200 relative to the solar cells 101 in the laminate 160 in accordance with embodiments of the present invention. It is to be noted that only six solar cells 101 are shown in FIG. 4 for clarity of illustration. Also, the in-laminate circuit 200 may be placed symmetrically, asymmetrically, or in other configuration in the laminate 160. The placement of the in-laminate circuits 200 in the laminate 160 and the number of electrical connections between an in-laminate circuit 200 and a solar cell 101 depend on the particular application.

The in-laminate circuits 200 are relatively flat and small, and accordingly would not bulge in the laminate 160, thereby preventing degradation of the backsheet and the laminate 160 in general. An electrical connection between an in-laminate circuit 200 and a solar cell 101 may be made by way of an in-laminate interconnect 212 (e.g., an electrically conductive wire).

As shown in FIG. 4, an in-laminate circuit 200 may be disposed in an interstitial area between solar cells 101. For example, an in-laminate circuit 200-1 may be placed in a diamond-shaped area between four solar cells 101. An interconnect 212 may electrically connect a node 201 to the in-laminate circuit 200-1, and another interconnect 212 may electrically connect a node 202 to the in-laminate circuit 200-1. This allows the in-laminate circuit 200-1 to be electrically connected to adjacent solar cells 101 on the same column in the solar cell array.

As another example, an in-laminate circuit 200-2 may be disposed in a diamond-shaped area between four solar cells 101, with an interconnect 212 electrically connecting a node 203 to the in-laminate circuit 200-2, and another interconnect 212 electrically connecting a node 204 to the in-laminate circuit 200-2. This allows the in-laminate circuit 200-2 to be electrically connected to adjacent solar cells 101 on the same row in the solar cell array.

As another example, an in-laminate circuit 200-3 may be disposed along a row of solar cells 101, with an interconnect 212 electrically connecting the in-laminate circuit 200-3 on a node 205 and another interconnect 212 electrically connecting the in-laminate circuit 200-3 on a node 206. The in-laminate circuit 200-3 may be disposed between an edge of the laminate and a row of solar cells 101, or between rows of solar cells 101. The in-laminate circuit 200-3 may be electrically connected to non-adjacent solar cells 101 in the solar cell array, and span several solar cells 101.

An in-laminate circuit 200 and an external circuit in the enclosure 150 may be configured to form a power conversion circuit suitable for a given application.

Generally speaking, embodiments of the present invention may include various DC-DC converter topologies, including half-bridge, full-bridge, synchronous, asynchronous, resonant, nonresonant, hard-switched, soft-switched, and so on, converter topologies. Embodiments of the present invention may also include various types DC-AC converters, such as DC link converters, AC link converters, and varieties thereof (e.g., half-bridge, full-bridge, resonant, nonresonant, hard-switched, and soft-switched, etc.). Furthermore, physically large capacitors (e.g., DC link capacitors) may be implemented using a number of active filtering techniques to reduce the amount of capacitance.

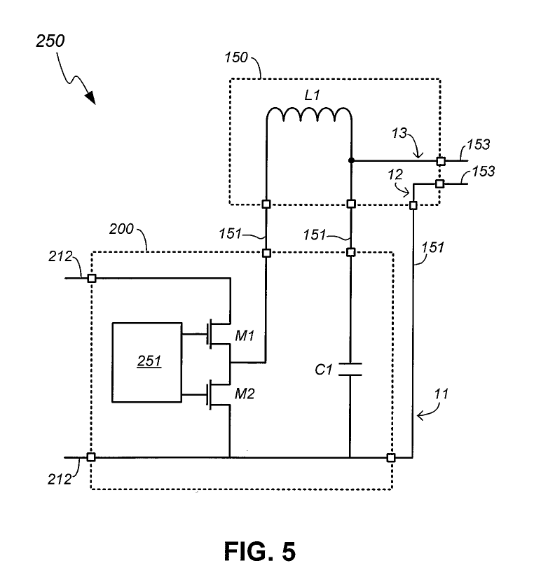

FIG. 5 is a schematic diagram of a power conversion circuit 250 in accordance with an embodiment of the present invention. In the example of FIG. 5, the power conversion circuit 250 is configured as a buck (i.e., step-down) DC-DC converter comprising an in-laminate circuit 200 and an external magnetic circuit housed in an enclosure 150. In the example of FIG. 5, the in-laminate circuit 200 comprises transistors M1 and M2 (e.g., metal oxide semiconductor (MOS) transistors), a control circuit 251, and an output capacitor C1. The capacitor C1 may comprise a planar (topography wise) capacitor, such as a ceramic capacitor or a capacitor suitable for fabrication in an IC (e.g., MOS capacitor). Use of a planar capacitor allows for a relatively planar package suitable for in-laminate installation. Examples of non-planar capacitors, which may be located external to the laminate, include film and electrolytic capacitors.

The control circuit 251 may be configured to control the control electrodes (e.g., gates) of the transistors M1 and M2 to perform buck DC-DC conversion using any suitable, conventional control scheme. A first electrode (e.g., drain) of the transistor M1 may be electrically connected to a node of a solar cell 101 by way of an in-laminate interconnect 212 and a second electrode (e.g., source) of the transistor M1 may be electrically connected to a first electrode (e.g., drain) of the transistor M2. A second electrode (e.g., source) of the transistor M2 and a first end of the capacitor C1 may be electrically connected to a node of a solar cell 101 by way of an in-laminate interconnect 212, which is electrically connected to the enclosure 150 by way of an electrical connection 151 (see arrow 11) and out of the enclosure 150 by way of an electrical wiring 153 (see arrow 12).

In the example of FIG. 5, the external magnetic circuit in the enclosure 150 comprises an output inductor L1. The output inductor L1 is physically large, and is thus installed in the enclosure 150. A first end of the inductor L1 may be electrically connected to a switch node of the transistors M1 and M2 by way of an electrical connection 151, and a second end of the inductor L1 may be electrically connected to a second end of the capacitor C1 by way of another electrical connection 151. The second end of the capacitor C1 and the second end of the inductor L1 may be electrically connected to another circuit by way of an electrical wiring 153 (see arrow 13).

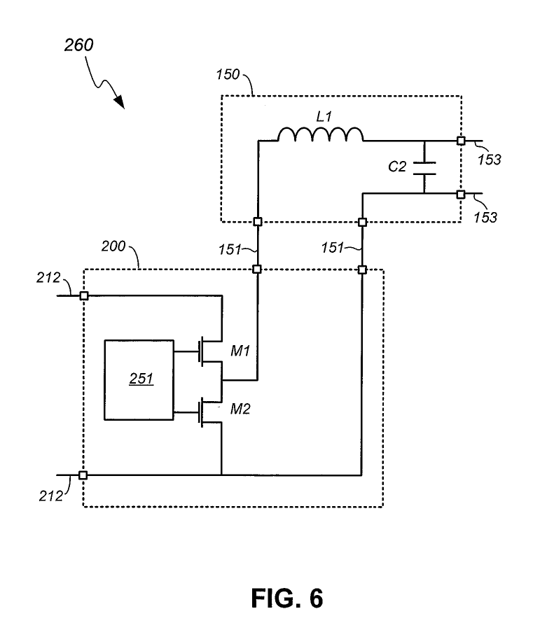

FIG. 6 is a schematic diagram of a power conversion circuit 260 in accordance with an embodiment of the present invention. The power conversion circuit 260 is the same as the power conversion circuit 250, except for the use of a non-planar output capacitor C2, e.g., an electrolytic capacitor. An electrolytic capacitor is relatively large and bulky and is generally not suitable for in-laminate installation.

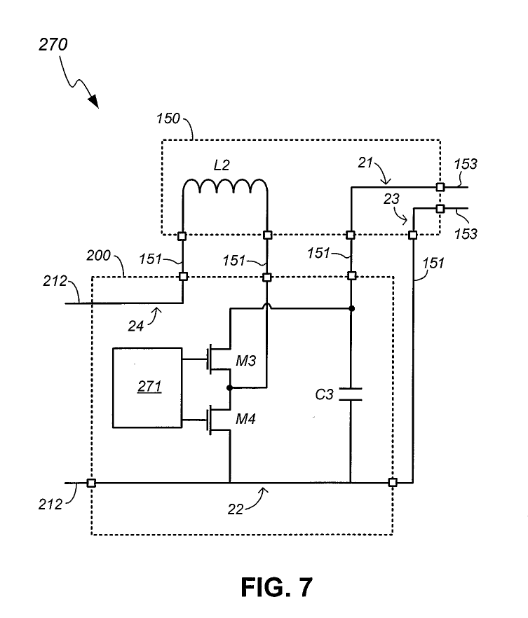

FIG. 7 is a schematic diagram of a power conversion circuit 270 in accordance with an embodiment of the present invention. In the example of FIG. 7, the power conversion circuit 270 is configured as a boost (i.e., step-up) DC-DC converter comprising an in-laminate circuit 200 and an external magnetic circuit in an enclosure 150. In the example of FIG. 7, the in-laminate circuit 200 comprises transistors M3 and M4 (e.g., metal oxide semiconductor (MOS) transistors), a control circuit 271, and a capacitor C3. The capacitor C3 may comprise a non-electrolytic capacitor, such as a ceramic or other planar capacitor.

The control circuit 271 may be configured to control the control electrodes (e.g., gates) of the transistors M3 and M4 to perform boost DC-DC conversion using any suitable, conventional control scheme. A first electrode (e.g., drain) of the transistor M3 may be electrically connected to a first end of the capacitor C3, which is electrically connected through the enclosure 150 by way of an electrical connection 151 and an electrical wiring 153 (see arrow 21).

A second electrode (e.g., source) of the transistor M3 may be electrically connected to a first electrode (e.g., drain) of the transistor M4, and a second electrode (e.g., source) of the transistor M4 may be electrically connected to a second end of the capacitor C3, which is electrically connected to a node of a solar cell 101 by way of an in-laminate interconnect 212 (see arrow 22) and through the enclosure 150 by way of an electrical connection 151 and an electrical wiring 153 (see arrow 23).

In the example of FIG. 7, an output inductor L2 is housed in the enclosure 150. A switch node of the transistors M3 and M4 is electrically connected to a first end of the inductor L2, and a second end of the inductor L2 is electrically connected to a node of a solar cell 101 by way of an in-laminate interconnect 212 (see arrow 24).

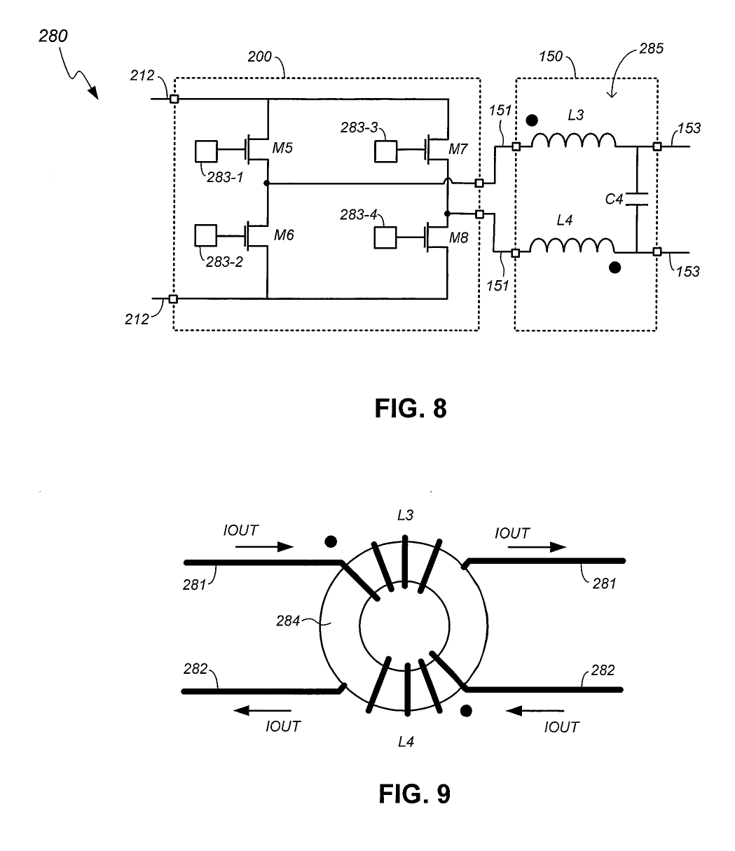

FIG. 8 is a schematic diagram of a power conversion circuit 280 in accordance with an embodiment of the present invention. In the example of FIG. 8, the power conversion circuit 280 comprises a photovoltaic inverter. The power conversion circuit 280 comprises an in-laminate circuit 200 comprising two half bridges and an external magnetic circuit 285 housed in the enclosure 150.

In the example of FIG. 8, the in-laminate circuit 200 comprises transistors M5-M8 (e.g., MOS transistors), which are driven by a control circuit 283 (i.e., 283-1, 283-2, 283-3, 283-4) by pulse width modulation (PWM). A first electrode (e.g., drain) of the transistor M5 and a first electrode (e.g., drain) of the transistor M7 are electrically connected to a node of a solar cell 101 by way of an in-laminate interconnect 212. A first electrode (e.g., drain) of the transistor M6 is electrically connected to a second electrode (e.g., source) of the transistor M5 to form a first half-bridge circuit. A first electrode (e.g., drain) of the transistor M8 is electrically connected to a second electrode (e.g., source) of the transistor M7 to form a second half-bridge circuit. The first and second half-bridge circuits together form a full-bridge circuit. A second electrode (e.g., source) of the transistor M6 and a second electrode (e.g., source) of the transistor M8 are electrically connected to a node of a solar cell 101 by way of an in-laminate interconnect 212.

In the example of FIG. 8, the control circuit 283 drives the control electrodes (e.g., gates) of the transistors M5-M8 with a modulated high-frequency pulse (e.g., 100 kHz) to generate a low-frequency output (e.g., 60 Hz) at the switch nodes of the two half-bridge circuits. The control circuit 283 may implement a suitable control scheme without detracting from the merits of the present invention.

In the example of FIG. 8, the magnetic circuit 285 is a differential inductor filter comprising inductors L3 and L4 and a capacitor C4 (e.g., electrolytic capacitor). The switch node between the transistors M5 and M6 is electrically connected to a first end of the inductor L3 by way of an electrical connection 151, and the switch node between the transistors M7 and M8 is electrically connected to a first end of the inductor L4. The capacitor C4 is electrically connected across the second ends of the inductors L3 and L4. The AC output of the power conversion circuit is across the capacitor C4 and made available by way of electrical wirings 153.

The present disclosure follows the dot marking convention for magnetic components, which indicates inductor wire turn orientation. In the example of FIG. 8, the magnetic circuit 285 is configured as a differential inductor filter. A single inductor may be used, but splitting the single inductor into the inductors L3 and L4 (that together have the same inductance as the single inductor) allows for a balanced configuration. The inductors L3 and L4 carry the same current and are thus in series connection. In one embodiment, the inductors L3 and L4 are wound on the same magnetic core. Generally speaking, in embodiments of the present invention, inductors may be wound on the same magnetic core or on separate magnetic cores.

FIG. 9 is a structural representation of the inductors L3 and L4 in accordance with an embodiment of the present invention. In the example of FIG. 9, the inductors L3 and L4 share the same magnetic core 284 (e.g., toroidal magnetic core). More particularly, the inductor L3 comprises a wire 281 that is wound on the magnetic core 284, and the inductor L4 comprises a wire 282 that is also wound on the magnetic core 284. In FIG. 9, the arrows indicate the direction of the output current IOUT. In accordance with the dot marking convention indicated by the dots in FIGS. 8 and 9, the wires 281 and 282 are wound in the same direction (e.g., both clockwise or both counter-clockwise) around the magnetic core 284. That is, when positive currents flow into the dot-marked end, the resulting flux adds constructively. The differential inductor filter formed by the inductors L3 and L4 advantageously filters noise arising from the PWM control of the transistors M5-M8 by the control circuit 283.

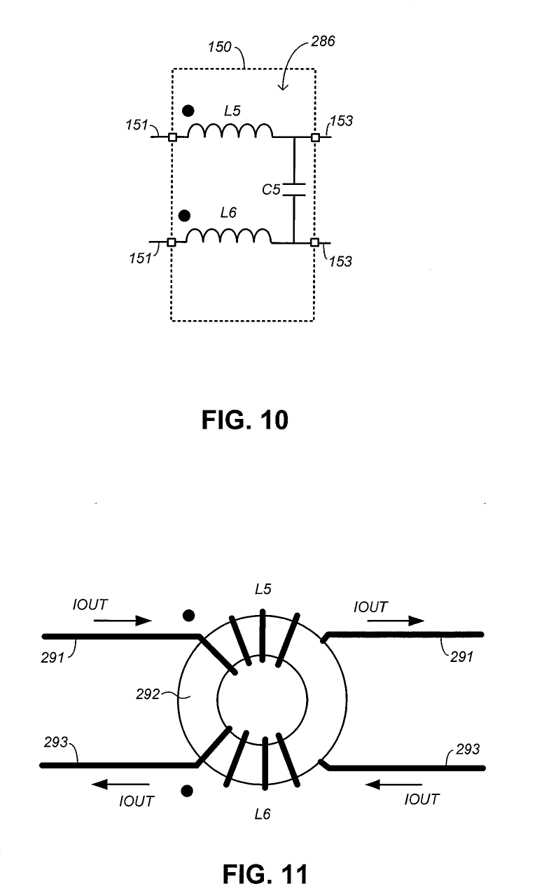

FIG. 10 is a schematic diagram of a magnetic circuit 286 in accordance with an embodiment of the present invention. The magnetic circuit 286 is housed in the enclosure 150, and may be used in the power conversion circuit 280 of FIG. 8, instead of the magnetic circuit 285. The magnetic circuit 286 may be electrically connected to the in-laminate circuit 200 of the power conversion circuit 280 in the same manner as the magnetic circuit 285. In the example of FIG. 10, the magnetic circuit 286 comprises inductors L5 and L6 and a capacitor C5 (e.g., electrolytic capacitor), which form a common mode inductor filter.

FIG. 11 is a structural representation of the inductors L5 and L6 in accordance with an embodiment of the present invention. In the example of FIG. 11, the inductors L5 and L6 share the same magnetic core 292 (e.g., toroidal magnetic core). More particularly, the inductor L5 comprises a wire 291 that is wound on a magnetic core 292, and the inductor L6 comprises a wire 293 that is also wound on the magnetic core 292. In FIG. 11, the arrows indicate the direction of the output current IOUT. In accordance with the dot marking convention indicated by the dots in FIGS. 10 and 11, the wires 291 and 293 are wound in opposite directions (i.e., one is wound clockwise, and the other is wound counter-clockwise) around the magnetic core 292. That is, when positive currents flow into the dot-marked end, the resulting flux adds destructively (i.e., subtracts).

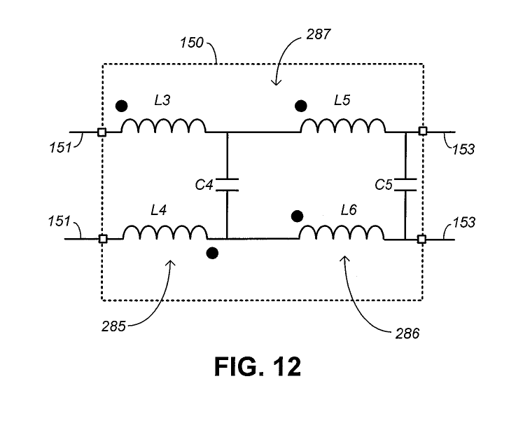

The common mode inductor filter configuration of the magnetic circuit 286 may be advantageously employed to filter noise that is common to both lines going into and out of the magnetic circuit 286. The common mode configuration of the magnetic circuit 286 and the differential configuration of the magnetic circuit 285 may be employed together and housed in the enclosure 150. This feature of the present invention is illustrated in FIG. 12.

FIG. 12 is a schematic diagram of a magnetic circuit 287 in accordance with an embodiment of the present invention. In the example of FIG. 12, the magnetic circuit 287 comprises the magnetic circuit 285 as a first stage and the magnetic circuit 286 as a following second stage. More particularly, in the example of FIG. 12, the magnetic circuit 285 is electrically connected to an in-laminate circuit 200 by way of electrical connections 151, and the output of the magnetic circuit 285 is electrically connected to the input of the magnetic circuit 286. The output of the magnetic circuit 286 is electrically connected to another circuit outside the enclosure 150 by way of electrical wirings 153. In the example of FIG. 12, the magnetic circuit 285 is configured to filter noise arising from PWM and the magnetic circuit 286 is configured to filter common mode noise.

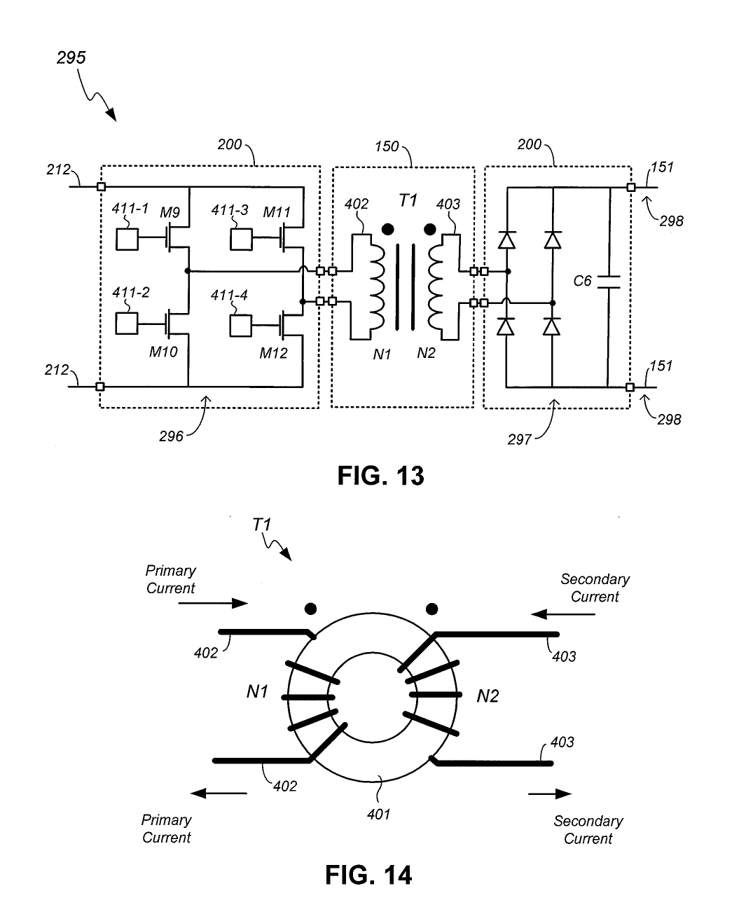

FIG. 13 is a schematic diagram of a power conversion circuit 295 in accordance with an embodiment of the present invention. In the example of FIG. 13, the power conversion circuit 295 is configured as a DC-DC converter comprising an in-laminate circuit 200 and a transformer T1 that is housed in the enclosure 150. In the example of FIG. 13, the in-laminate circuit 200 comprises a full-bridge circuit 296, a rectifier circuit 297, and an output capacitor C6 (e.g., planar capacitor).

In the example of FIG. 13, the full-bridge circuit 296 comprises transistors M9-M12, which are driven by a control circuit 411 (i.e., 411-1, 411-2, 411-3, and 411-4) by PWM. A first electrode (e.g., drain) of the transistor M9 and a first electrode (e.g., drain) of the transistor M11 are electrically connected to a node of a solar cell 101 by way of an in-laminate interconnect 212. A first electrode (e.g., drain) of the transistor M10 is electrically connected to a second electrode (e.g., source) of the transistor M9 to form a first half-bridge circuit. A first electrode (e.g., drain) of the transistor M12 is electrically connected to a second electrode (e.g., source) of the transistor M11 to form a second half-bridge circuit. The first and second half-bridge circuits together form a full-bridge circuit. A second electrode (e.g., source) of the transistor M10 and a second electrode (e.g., source) of the transistor M12 are electrically connected to a node of a solar cell 101 by way of an in-laminate interconnect 212.

In the example of FIG. 13, the control circuit 411 drives the control electrodes (e.g., gates) of the transistors M9-M12 with a modulated high-frequency pulse (e.g., 100 kHz) to generate a low-frequency output (e.g., 60 Hz) at the switch nodes of the two half-bridge circuits. The control circuit 411 may implement a suitable control scheme without detracting from the merits of the present invention.

In the example of FIG. 13, the transformer T1 comprises a primary winding 402 and a secondary winding 403, with a primary winding to secondary winding turns ratio of N1:N2. The output of the full-bridge circuit 296 is electrically connected to the primary winding 402, and the secondary winding 402 is electrically connected to the input of the rectifier circuit 297. Electrical connections 151 between the switch nodes of the full-bridge circuit 296 and the primary winding 402 and between the secondary winding 403 and the input of the rectifier circuit 297 are not labeled in FIG. 13. The rectified output is across the capacitor C6, which is electrically connected to an external circuit outside the laminate by way of electrical connections 151 (see arrows 298), which may be routed through the enclosure 150 to corresponding electrical wirings 153 (not shown).

In the example of FIG. 13, the output capacitor C6 is within the laminate. In other embodiments, when the output capacitor is physically large (e.g., electrolytic capacitor), the output capacitor C6 may be located in the enclosure 150 and electrically connected to in-laminate components by way of electrical connections 151 (not shown).

FIG. 14 is a is a structural representation of the transformer T1 in accordance with an embodiment of the present invention. In the example of FIG. 14, the primary winding 402 and the secondary winding 403 are wound around the same magnetic core 401 (e.g., toroidal magnetic core). In FIG. 14, the arrows indicate the direction of the primary current through the primary winding 402 and the direction of the secondary current through the secondary winding 403. In accordance with the dot marking convention indicated by the dots in FIGS. 13 and 14, the primary winding 402 and the secondary winding 403 are wound in opposite directions (i.e., one is wound clockwise, and the other is wound counter-clockwise) around the magnetic core 401.

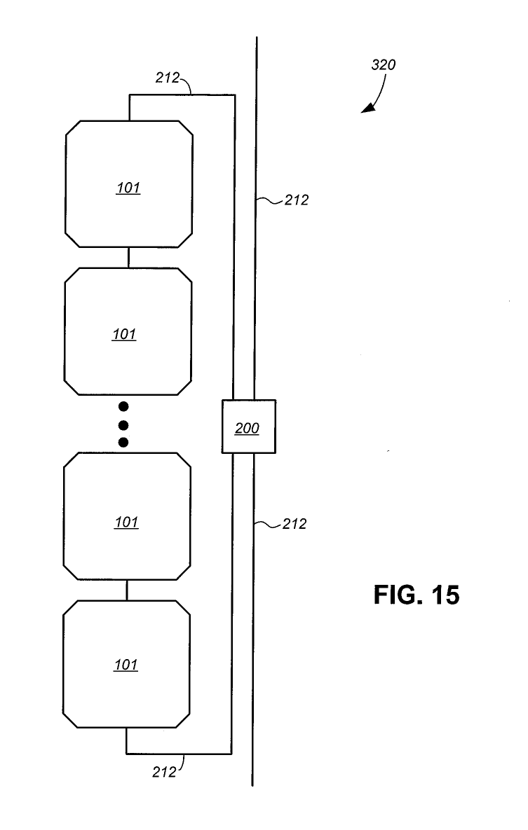

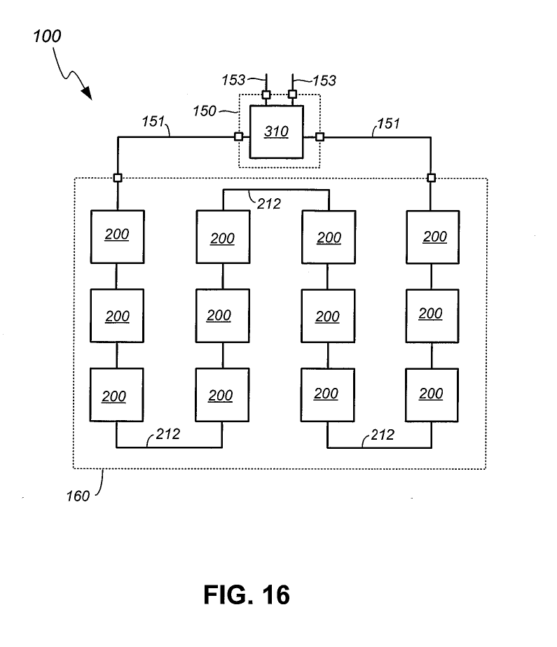

FIG. 15 is a schematic diagram of a substring 320 of a photovoltaic module 100 in accordance with an embodiment of the present invention. In one embodiment, a photovoltaic module 100 includes a plurality of solar cells 101 that are divided into several substrings 320. In the example of FIG. 15, each substring 320 has a corresponding in-laminate circuit 200 that is configured as a DC-DC converter. A DC-DC converter of a substring 320 may be electrically connected in series to an adjacent DC-DC converter of another substring 320 by way of an in-laminate interconnect 212, with the output of the DC-DC converters being connected to a microinverter of the photovoltaic module 100, as discussed below with reference to FIG. 16. Dividing the solar cells 101 of the photovoltaic module 100 into a plurality of substrings advantageously confines the effect of shading or other negative conditions on one or more substrings rather than on the entire solar cell array.

FIG. 16 is a schematic diagram of a photovoltaic module 100 in accordance with an embodiment of the present invention. In the example of FIG. 16, each in-laminate circuit 200 comprises a DC-DC converter of a substring 320. The corresponding solar cells 101 of the substrings 320 are not shown in FIG. 16 for clarity of illustration. The in-laminate circuits 200 of FIG. 16 are electrically connected in series by way of in-laminate interconnects 212 within the photovoltaic laminate 160. The combined output of the DC-DC converters that are implemented as in-laminate circuits 200 in FIG. 16 is provided to a microinverter 310.

In the example of FIG. 16, the microinverter 310 is housed in an enclosure 150. The microinverter 310 is electrically connected to the in-laminate circuits 200 by way of electrical connections 151. The output of the microinverter 310 may be electrically connected to another circuit (e.g., the power grid) by way of electrical wirings 153.

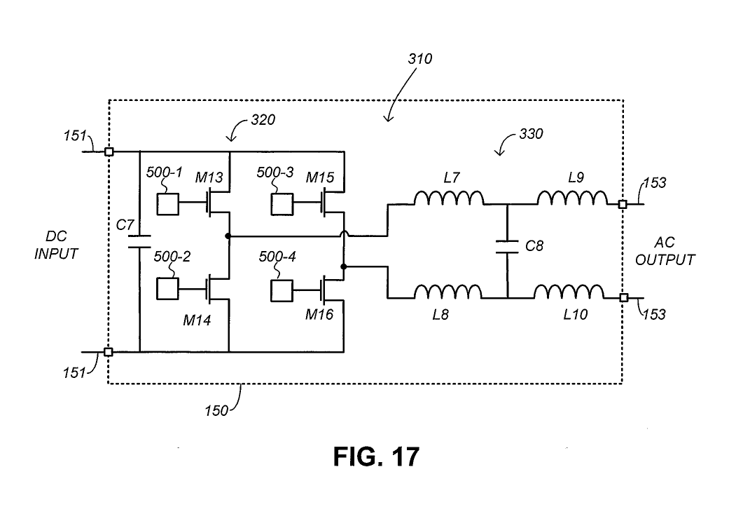

FIG. 17 is a schematic diagram of the microinverter 310 in accordance with an embodiment of the present invention. In the example of FIG. 17, the microinverter 310 comprises a full-bridge circuit 320 and an output filter 330 that are housed in the enclosure 150. The output of the DC-DC converters of the in-laminate circuits 200 are received as the DC input to the full-bridge circuit 320. The DC input is received across a DC link capacitor C7 (e.g., large electrolytic or film capacitor), which is a physically large capacitor and is thus advantageously located outside the laminate.

In the example of FIG. 17, the full-bridge circuit 320 comprises transistors M13-M16 (e.g., MOS transistors), which are driven by a control circuit 500 (i.e., 500-1, 500-2, 500-3, 500-4) by PWM. A first electrode (e.g., drain) of the transistor M13 and a first electrode (e.g., drain) of the transistor M15 are electrically connected to an in-laminate circuit 200 by way of an electrical connection 151. A first electrode (e.g., drain) of the transistor M14 is electrically connected to a second electrode (e.g., source) of the transistor M13 to form a first half-bridge circuit. A first electrode (e.g., drain) of the transistor M16 is electrically connected to a second electrode (e.g., source) of the transistor M15 to form a second half-bridge circuit. The first and second half-bridge circuits together form a full-bridge circuit. A second electrode (e.g., source) of the transistor M14 and a second electrode (e.g., source) of the transistor M16 are electrically connected to an in-laminate circuit 200 by way of an electrical connection 151.

In the example of FIG. 17, the control circuit 500 drives the control electrodes (e.g., gates) of the transistors M13-M16 with a modulated high-frequency pulse (e.g., 100 kHz) to generate a low-frequency output (e.g., 60 Hz) at the switch nodes of the two half-bridge circuits. The control circuit 500 may implement a suitable control scheme without detracting from the merits of the present invention.

In the example of FIG. 17, the output filter 330 comprises inductors L7-L10 and a capacitor C8. The switch nodes between the transistors M13 and M14 and between the transistors M15 and 16 are electrically connected to the input of the output filter 330 within the enclosure 150. The AC output of the microinverter 310 is provided across the electrical wirings 153 at the output of the output filter 330.

Photovoltaic modules with distributed power conversion circuits have been disclosed. While specific embodiments of the present invention have been provided, it is to be understood that these embodiments are for illustration purposes and not limiting. Many additional embodiments will be apparent to persons of ordinary skill in the art reading this disclosure.

What is claimed is:

1. A photovoltaic module comprising:
a plurality of solar cells;
a first subcircuit of a power conversion circuit, the first subcircuit being electrically connected to a solar cell of the plurality of solar cells;
an encapsulant that encapsulates the plurality of solar cells and the first subcircuit within the encapsulant; and
a second subcircuit of the power conversion circuit, the second subcircuit being disposed outside the encapsulant, the second subcircuit comprising a magnetic component.

2. The photovoltaic module of claim 1, wherein the magnetic component comprises a first inductor that is housed in an external enclosure of the photovoltaic module.

3. The photovoltaic module of claim 2, wherein the second subcircuit further comprises a second inductor that is also housed in the external enclosure, and wherein the first inductor and the second inductor comprise wires that are wound on a same magnetic core.

4. The photovoltaic module of claim 3, wherein the external enclosure comprises a junction box.

5. The photovoltaic module of claim 2, wherein the second subcircuit comprises an inductor filter.

6. The photovoltaic module of claim 1, wherein the first subcircuit is implemented in a semiconductor die.

7. The photovoltaic module of claim 1, wherein the power conversion circuit comprises a DC-DC converter.

8. The photovoltaic module of claim 1, wherein the power conversion circuit comprises a microinverter.

9. A photovoltaic module comprising:
a first group of solar cells that are connected in series;
a first DC-DC converter across the first group of solar cells;
an encapsulant that encapsulates the first group of solar cells and the first DC-DC converter; and
a microinverter outside the encapsulant, the microinverter being configured to convert a DC output of the first DC-DC converter to an AC output.

10. The photovoltaic module of claim 9, further comprising:
a second group of solar cells that are connected in series;
a second DC-DC converter across the second group of solar cells, the second DC-DC converter being connected in series with the first DC-DC converter,
wherein the encapsulant encapsulates the first and second groups of solar cells and the first and second DC-DC converters.

11. The photovoltaic module of claim 10, wherein the microinverter is configured to convert the DC output of the first DC-DC converter and a DC output of the second DC-DC converter to the AC output.

12. The photovoltaic module of claim 9, further comprising a junction box that is disposed outside the encapsulant, the junction box being configured to house the microinverter.

13. A photovoltaic module comprising:
a plurality of solar cells;
a first semiconductor die disposed between solar cells of the plurality of solar cells, the first semiconductor die comprising a subcircuit of a power conversion circuit;
an encapsulant that encapsulates the plurality of solar cells and the first semiconductor die within the encapsulant; and
a magnetic component of the power conversion circuit, the magnetic component being disposed outside the encapsulant.

14. The photovoltaic module of claim 13, wherein the first semiconductor die is in a first interstitial area formed by a first set of four solar cells of the plurality of solar cells.

15. The photovoltaic module of claim 14, further comprising a second semiconductor die of a second power conversion circuit, the second semiconductor die being formed in a second interstitial area formed by a second set of four solar cells of the plurality of solar cells.

16. The photovoltaic module of claim 13, wherein the first semiconductor die is disposed along an edge of a solar cell of the plurality of solar cells.

17. The photovoltaic module of claim 13, wherein the magnetic component of the power conversion circuit comprises a magnetic core and a wire that is wrapped around the magnetic core a plurality of times.

18. The photovoltaic module of claim 13, further comprising a junction box that houses the magnetic component of the power conversion circuit.

19. The photovoltaic module of claim 18, wherein the junction box further houses an electrolytic capacitor of the power conversion circuit.

20. The photovoltaic module of claim 13, wherein the power conversion circuit is a DC-DC converter.
